(19) United States
(12) Patent Application Publication
(10) Pub. No.: US 2018/0143024 A1
(43) Pub. Date: May 24, 2018

(54) AUTOMATED GENERATION OF INDOOR MAP DATA

(71) Applicant: Microsoft Technology Licensing, LLC, Redmond, WA (US)

(72) Inventors: Jonathan Matthew Kay, Redmond, WA (US); Stephen P. DiAcetis, Duvall, WA (US); David Mahlon Hoover, Woodinville, WA (US); Cristina del Amo Casado, Seattle, WA (US); Jyh-Han Lin, Mercer Island, WA (US)

(21) Appl. No.: 15/358,555

(22) Filed: Nov. 22, 2016

(51) Int. Cl. G01C 21/20; H04W 4/04; H04W 4/02; G01S 5/02

(52) U.S. Cl. CPC G01C 21/206; H04W 4/043; G01S 5/0252; H04W 4/028; H04W 4/027

(57) ABSTRACT

Techniques described herein generate indoor map data. Generally described, configurations disclosed herein generate indoor map data using positioning data and interaction data associated with the movement and interactions of user computing devices. For example, techniques disclosed herein can enable a computing system to identify floors of a building, hallways, offices, doors, common areas, and other resources, including computing resources, based on the movement of users and the interaction of the users with resources within the indoor environment.

### BACKGROUND

The tasks involved with generating map data for an indoor environment can present challenges for companies of all sizes. While there are a number of technologies for generating map data for streets and vehicle pathways, current technologies are limited for generating map data for indoor environments. For instance, the current technologies generally require the manual identification for indoor pathways, rooms and other indoor resources for a building, such as computer equipment, projectors, printers, etc.

It is with respect to these and other considerations that the disclosure made herein is presented.

### SUMMARY

Techniques described herein provide automated generation of map data. Generally described, configurations disclosed herein enable a system to generate indoor map data and/or outdoor map data using data associated with the movement of users and the interaction of the users with resources within the indoor environment. For example, techniques disclosed herein can enable a computing system to receive positioning data and interaction data from user computing devices. The system can generate the map data using the positioning data and the interaction data.

The indoor map data identifies resources of the indoor environment. The resources can include computing device resources and non-computing device resources within the indoor environment. For example, the map data can identify interior pathways, doorways, rooms, or other areas within the indoor environment, as well as other computing resources and non-computing resources. As an example, the map data can identify the boundaries of hallways, offices, common areas, tables, chairs, desks, the location of resources such as printers, copiers, fax machines, as well as identify other types of computing devices and other physical objects with which a user interacts.

In some configurations, the techniques disclosed herein can enable a system to provide automated generation of indoor map data based, at least in part, on positioning data received from user computing devices. The positioning data indicates the movement of user devices within the environment. In addition, the positioning data can be used by the system to identify movement patterns of user devices. The positioning data can include various types of data, such as a velocity of a user, a direction of a user, a number of steps taken by the user, and the like. In some cases, the positioning data may be relative to some known location. For example, a location of a user within the indoor environment can be determined using a wireless fidelity (WI-FI) positioning system and/or using sensors available on a user computing device.

The system can also identify resources within the indoor environment based on the positioning data and/or interaction data obtained during an interaction between a user and the resource. For example, as a user travels through rooms and hallways of a building, a user device can scan for resources. As the device scans for resources, interaction data can be generated and sent to the system. In other examples, the user may send a command to a computing resource or receive data from a computing resource. For instance, the user may send a print command to a printer within the office and/or receive a fax notification message from a fax machine located within the office. The interaction data can associate a particular resource with a location within the building. The computing resources identified using the interaction data can include any computing device, such as a networking device, printer, computer, controlled-access point (e.g., a secured door), or any other device connected to a wired or wireless network. In yet other examples, the system can identify other physical resources within the environment. For instance, the system can use the positioning data and/or interaction data to identify a location of desks, chairs, tables within the environment.

For illustrative purposes, consider a scenario where an indoor environment has not been mapped. Before the indoor environment is mapped little to no information may be known about the location of hallways, doorways, and other resources located within the indoor environment. In order to generate map data for an indoor environment, a system receives positioning data and interaction data from users within the indoor environment. The positioning data can be based on one more known locations within the environment. For example, the known location could be an outside location, a meeting room or office, or the like. This location might come from existing map data, information obtained from a calendar invitation, data entered by a user, an image of the location that includes location data, and the like. When a user moves throughout the indoor environment, stops at various locations within the indoor environment, and possibly interacts with a resource, the system can receive this positioning data and interaction data and use this data to generate the indoor map data. In some examples, the positioning data and the interaction data is used to incrementally improve the map data. For instance, the location of a resource might be adjusted, the location and/or size of a room might be adjusted, and the like.

In some configurations, the system can dynamically modify the generated map data based on positioning data and interaction data received after generating the map data. For example, the map data may not initially indicate the presence of a printer within the indoor environment. After identifying a pattern of movement to the printer and/or an interaction with the printer, the system can update the map data to show the presence of the printer. Similarly, the system can update the map data to better reflect the boundaries within the indoor environment. For instance, initially the map data may not reflect the true size of a room, but as more positioning data is obtained, the system can update the boundaries and other objects within the indoor environment.

The system may identify different rooms of an indoor environment using various criteria. For example, the mapping system may identify a conference room using positioning data that indicates group of users moving to the room at a particular time and then leaving the room after some period of time. In some configurations, the system can utilize data other than the positioning data in identifying the room as a conference room. For instance, a calendar invite may correlate that the user is attending a meeting at a particular time. In yet other configurations, shipping information that is associated with the delivery of packages to particular offices or specific locations could be utilized. For example, an office might be identified by the system based on packages being delivered to the office that are addressed to a particular user.

As the users enter the room, the positioning data can be used by the mapping system to identify the doorways to the conference room. The positioning data can be used by the mapping system to generate the boundaries of the walls as well as chairs and a table within the conference room. For example, the boundaries of walls within the indoor environment can be detected based on the patterns of movement identified from the positioning data received from user computing devices.

The system can also generate metadata that defines information about the boundaries of the indoor environment and resources identified within the indoor environment. For example, the metadata for an office may identify a size of the office, an identification of the user that uses the office and any resources identified within the office.

Configurations disclosed herein can receive and analyze positioning data received from a computing device associated with the user. As described in more detail below, positioning data received from one or more systems, such as one or more GPS devices, Bluetooth LE proximity beacons, wireless routers, W-Fi access points, or other suitable devices, can utilized by the techniques disclosed herein. In some configurations, the positioning data and/or interaction data can include the timing of various actions. For example, a printer might be recognized by interaction data indicating to print a document along with the user waiting at a particular location for a period of time before returning to a location. In addition, configurations disclosed herein can analyze other types of data from other systems to identify a user and the user's position and/or pattern of movement. For instance, the system can utilize imaging technologies, such as facial recognition, to identify a person moving within a field of view of a camera or other type of detector or sensor. Data indicating the position of the camera, heat sensor, motion detector, sound detector or any other type of detector or sensor, can be utilized to identify the position and/or pattern of movement of a detected user. In some configurations, positioning data and other data can be analyzed from multiple systems and multiple computing devices to identify a position or a pattern of movement of one or more users.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings. This Summary is provided to introduce a selection of concepts in a simplified form that are further described below in the Detailed Description.

This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the figures, the left-most digit(s) of a reference number identifies the figure in which the reference number first appears. The same reference numbers in different figures indicates similar or identical items. References made to individual items of a plurality of items can use a reference number with a letter of a sequence of letters to refer to each individual item. Generic references to the items may use the specific reference number without the sequence of letters.

FIGS. 1A-1E illustrate an example of a system that provides automated generation of indoor map data using positioning data and interaction data.

FIG. 2 is a diagram showing an illustrative system for automated generation of indoor map data.

FIGS. 3A-3B illustrate an example data flow scenario of a system that provides automated generation of indoor map data using positioning data and interaction data received from user computing devices.

FIG. 4 is a flow diagram showing a routine illustrating aspects of a mechanism disclosed herein for automated generation of indoor mapping data.

FIG. 5 is a computer architecture diagram illustrating an illustrative computer hardware and software architecture for a computing system capable of implementing aspects of the techniques and technologies presented herein.

FIG. 6 is a diagram illustrating a distributed computing environment capable of implementing aspects of the techniques and technologies presented herein.

FIG. 7 is a computer architecture diagram illustrating a computing device architecture for a computing device capable of implementing aspects of the techniques and technologies presented herein.

### DETAILED DESCRIPTION

The following Detailed Description describes technologies enabling automated generation of indoor map data. Generally described, configurations disclosed herein enable a system to generate indoor map data using positioning data associated with the movement of users and interaction data associated with the interaction of users with resources within an indoor environment. For example, techniques disclosed herein can enable a computing system to receive positioning data and interaction data from user computing devices as users move throughout the environment. The system can generate the indoor map data using the positioning data and the interaction data.

For illustrative purposes, consider a scenario where a floor of an office building has not been mapped. Before the floor is mapped little to no information may be known about the location of hallways, doorways, and other resources located on the floor. In some configurations, the system has one or more reference locations that can be used to add to the map data. For example, the system could know the outside boundaries of the building, the location of a doorway, room, or some other location within the environment. When users move throughout the floor, stop at various locations within the indoor environment, and interact with resources, a computing system can receive this positioning data and interaction data and use this data to generate the indoor map data. In some examples, the system can obtain data from specific users that move within the environment. For instance, the system can track the movement of security guards, delivery personnel, as well as other users that are likely to move throughout the environment.

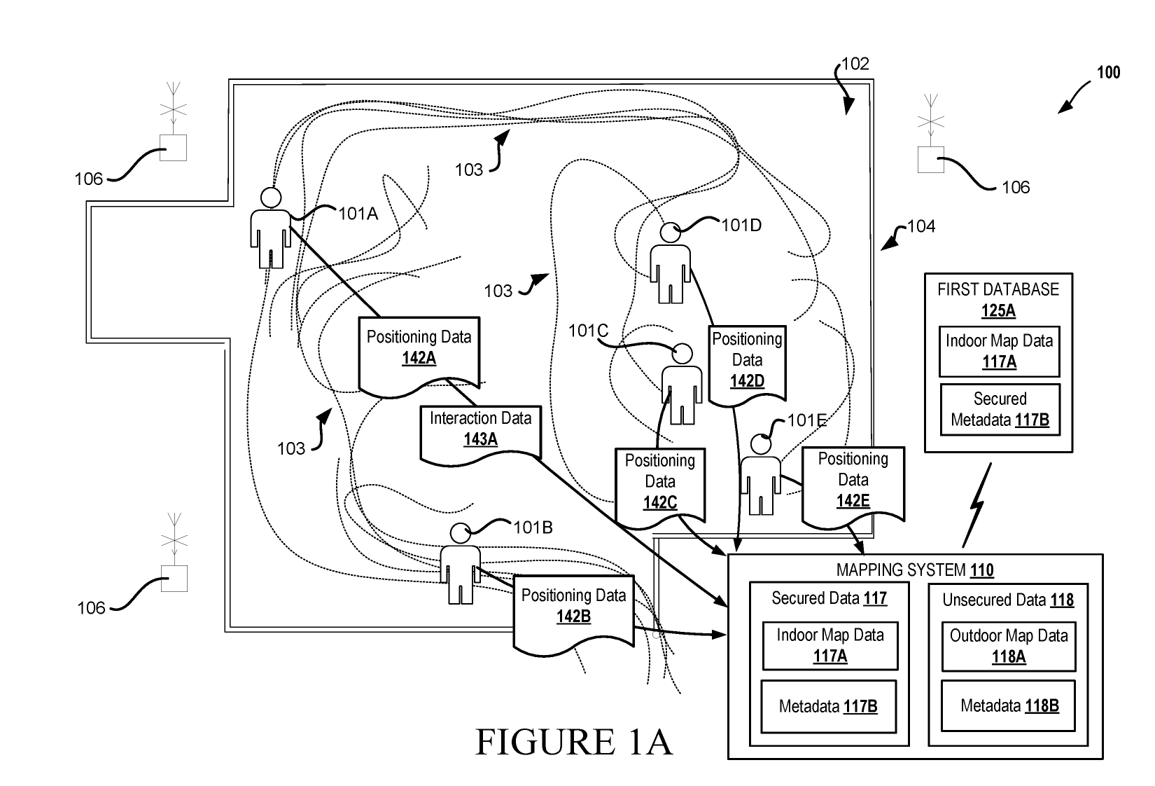

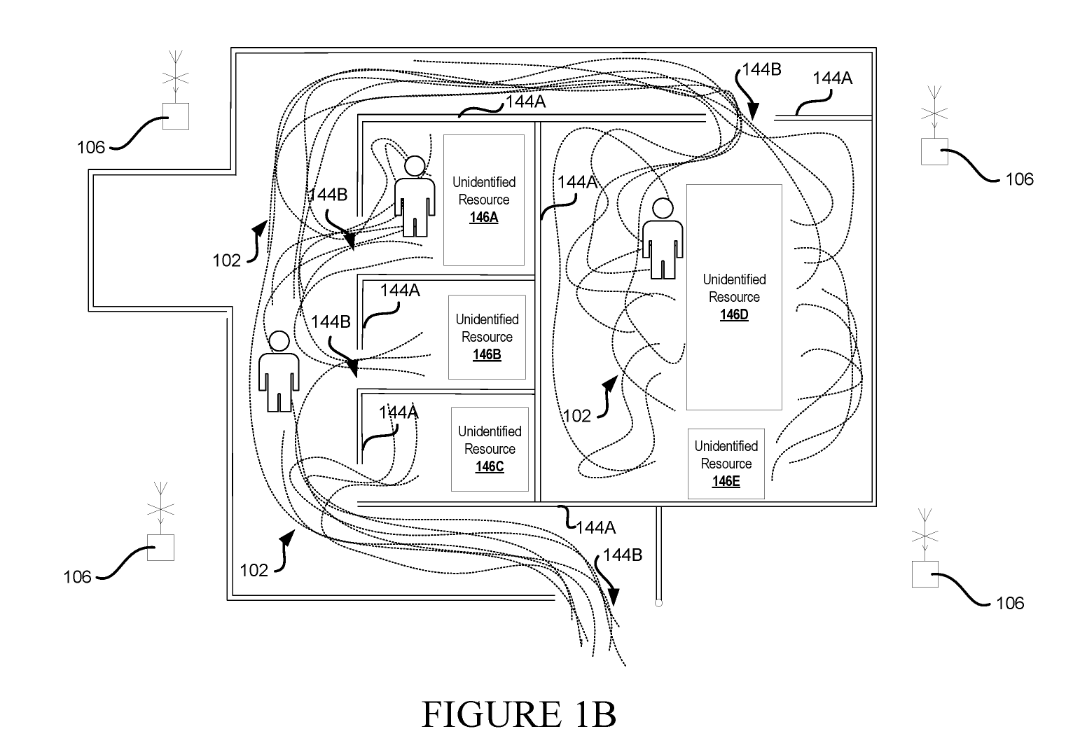

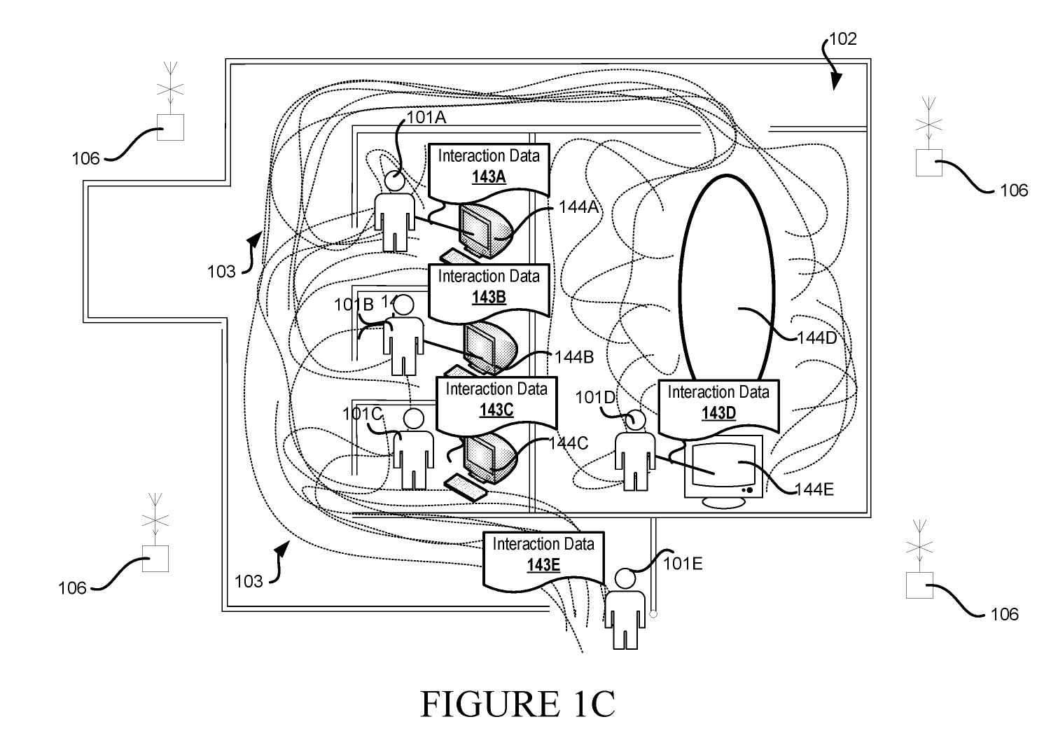

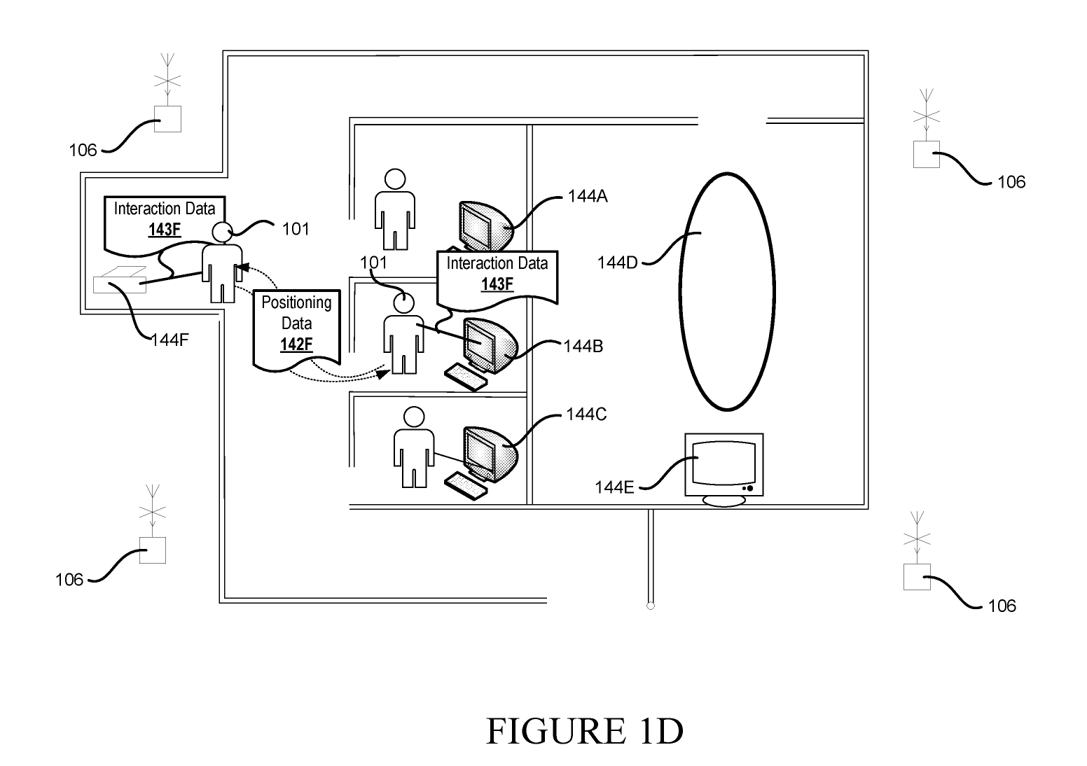

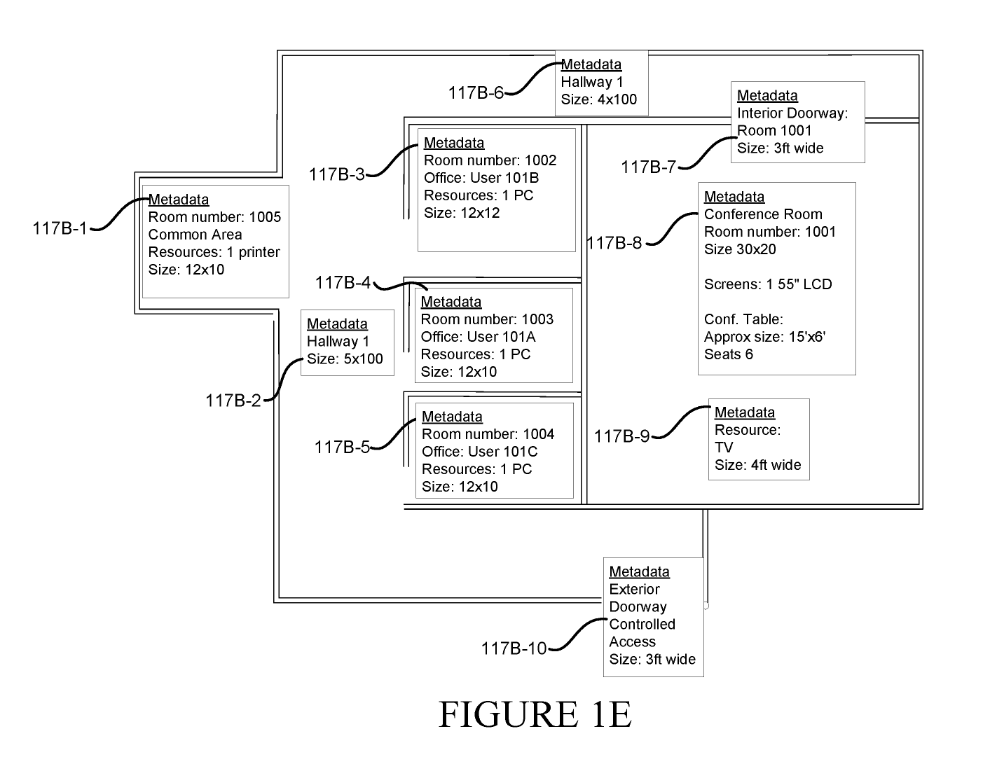

To illustrate aspects of the techniques disclosed herein, FIGS. 1A-1E illustrate an example of a system that provides automated generation of indoor map data using positioning data and interaction data. The example of FIGS. 1A-1E includes a representative floor 104 of an office building, which represents part of a larger building. Although this example includes an indoor office environment for a single floor, it can be appreciated that the techniques disclosed herein can be applied to any environment having one or more resources. For instance, the techniques disclosed herein can be applied to multiple floors of a building, isles in a supermarket or some other environment that includes isles, a school, a store, a factory, oil refinery, or any other environment that may benefit from a system that can provide different levels of access for different resources to individual identities or select groups of identities.

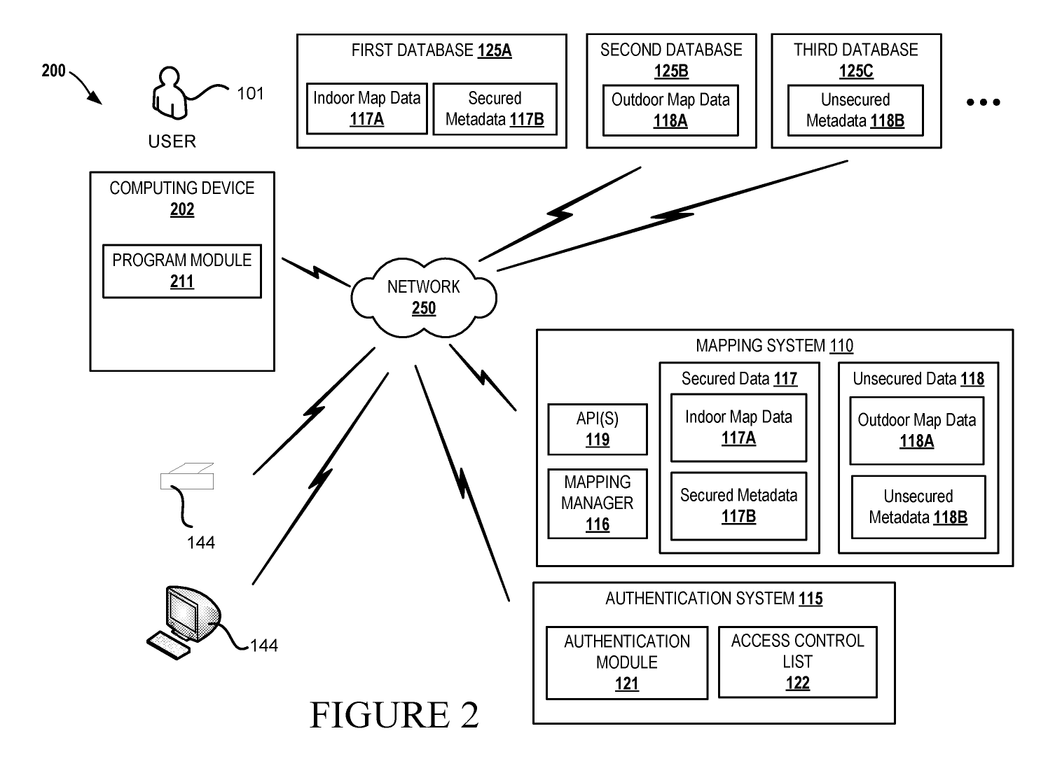

Turning now to FIG. 1A, the example illustrates a scenario where the resources of the indoor environment 102 have not been mapped. Stated another way, all or a portion of the indoor map data 117A has not been generated for the floor 104. In this example, a mapping system 110 generates indoor map data 117A using positioning data 142 associated with the movement of users and interaction data 143 associated with the interaction of the users with resources within the indoor environment. In some configurations, the mapping system 110 receives positioning data 142 and interaction data 143 from user computing devices, such as computing device 202 illustrated in FIG. 2.

As described above, resources can include computing device resources and non-computing device resources. For example, the resources can include interior pathways, doorways, rooms, or other areas within the indoor environment, as well as other computing resources and non-computing resources. As an example, the map data can identify the boundaries of hallways, offices, common areas, furniture, the location of resources such as printers, copiers, fax machines, as well as identify other types of computing devices and other physical objects with which a user interacts. The resources can be associated with one or more locations. As will be described in more detail below, an association between a resource and a location enables the mapping system 110 to generate indoor map data 117A based on positioning data 142 and interaction data 143 (see FIG. 1B).

As discussed briefly above, before the floor 104 is mapped little to no information may be known about the location of hallways, doorways, and other resources located on the floor. When users move throughout the floor, stop at various locations within the indoor environment, and interact with resources, the mapping system 110, or some other system, can receive this positioning data 142 and interaction data 143 and use this data to generate the indoor map data 117A.

Positioning data 142 indicating a location of a user 101 can be generated by a number of suitable technologies. For instance, positioning data 142 indicating a location of a user 101 can be generated by a mobile computing device. In another example, positioning data 142 indicating a location of a user 101 can be generated by a camera system utilizing profiling technologies, such as face recognition technologies, to identify and track the movement of a user. According to some configurations, one or more WI-FI access points 106 are positioned in locations around the floor 104. These access points 106 can be used to generate positioning data 142 that indicates the location of users and/or computing devices within the inside environment 102. Other wired or wireless technologies can be used to enable the mapping system 110 to determine when a person enters, moves within a particular area, enters a particular area, or exits a particular area.

In the example of FIG. 1A, positioning data 142 is obtained from users 101 that are moving through the indoor environment 102. As illustrated, a first user 101A is associated with positioning data 142A and interaction data 143A, user 101B is associated with positioning data 142B, user 101C is associated with positioning data 142C, user 101D is associated with positioning data 142D, and user 101E is associated with positioning data 142E. More of fewer users can gather positioning data 142 that can be used by the mapping system 110 to generate the indoor map data 117A.

As discussed briefly above, as a user 101 moves through the indoor environment 102, patterns of movement 103 for users are obtained. In the examples shown in FIGS. 1A-1D, the patterns of movement 103 are shown as dashed lines that indicate where one or more users 101 have traveled within the indoor environment 102. These patterns of movement 103 can be used by the mapping system 110 to determine boundaries of the indoor environment. For example, a wall, or object, can be identified based on the patterns of movement 103 for the users not going past a particular location, or entering a particular area. This example is provided for illustrative purposes and is not to be construed as limiting. Aspects of the present disclosure can be applied to any suitable environment 100 having any number of buildings or structures having any number of resources.

At this point in the example, the mapping system 110 is collecting positioning data 142 and interaction data 143 (as described in more detail with regard to FIG. 1C) and has not generated indoor map data 117A for the indoor environment 102. Generally, the more positioning data 142 and interaction data 143 obtained by the mapping system 110 results in more accurate indoor map data 117A. FIGS. 1B and 1C illustrate additional positioning data and patterns of movement 103.

In some configurations, the positioning data 142 and interaction data 143 collected by the mapping system 110 can be stored in a memory device. The stored positioning data 142 can indicate a time of various events, such as a time of stay at a particular location, a user's velocity, direction, ingress, egress, and other activity. The stored positioning data 142 can be used for auditing and/or machine learning purposes. As described herein, indoor map data 117A of an indoor environment 102 can be generated based on positioning data 142 and interaction data 143 received from one or more user devices.

Turning to FIG. 1B, the mapping system 110 uses received the positioning data 142A-142E as illustrated in FIG. 1A and generates indoor map data 117A. As illustrated, the indoor map data 117A shows resources that have been identified (e.g., walls, doorways, rooms) and unidentified resources 146A-146E that have not yet been identified. The map data 117A defines locations, and other characteristics of the resources based on the positioning data 142 and/or the interaction data 143.

For purposes of explanation, the example of FIG. 1B focuses on the use of positioning data 142, rather than the use of interaction data 143, in generating the indoor map data 117A. As can be seen by referring to FIG. 1B, the mapping system 110 has identified resources 144 including boundaries of interior walls 144A, rooms defined by the walls, and doorways 144B.

The mapping system 110 has also mapped unidentified resources 146A-146E. At this point, the mapping system 110 identifies that objects exist at the locations indicated by the unidentified resources 146 but does not have enough information to identify the resource 144. An unidentified resource 146 can be a computing resource or a non-computing resource. As described in more detail with regard to FIG. 1C, the mapping system 110 obtains further data, such as interaction data 143, and uses that data to identify the unidentified resources 146A-146E.

The mapping system 110 can utilize different techniques to generate the indoor map data 117A and metadata 117B. For instance, the mapping system 110 can utilize a mapping technique that identifies open areas and walled areas of the indoor environment 102 that is based on where the positioning data 142 indicates the areas in which users have freely moved and areas in which users have not moved within. The mapping system 110 can also utilize other information in generating the indoor map data 117A. For instance, the mapping system 110 can utilize other data sources that can provide information about the indoor environment 102. In some configurations, the mapping system 110 can generate metadata 117B that is associated with the indoor map data 117A.

Metadata, for instance, can comprise information describing, or information associated with, one or more facilities. For example, metadata can include, but is not limited to, data related to routing data associated with deliveries, route data for security guards or other personnel, rooms, hallways, common areas, restrooms, break rooms, walls, computing devices, printers, display screens, telephones, rooms of a building, security systems, network devices, and other types of resources. In some specific examples, metadata can include access codes and operational parameters one or more computing devices. In other examples, metadata can describe the contents of a room, an organizational chart associating individuals of the company with individual offices, or any other resource. Metadata can also describe a position and/or size of one or more resources. The control data, for instance, can comprise instructions, commands or other code for controlling computing devices or systems, such as security systems, elevator doors, secured doors, etc. Metadata can also include positioning data indicating a position of a user or resource. For example, metadata can indicate a position of a particular user, a group of users, a printer, a computer display screens, telephones, rooms of a building, security systems, network devices, and other types of resources. The metadata can also indicate a threshold level of accuracy with respect to the position of a user or resource.

In some configurations, the metadata can include map data defining aspects of buildings or other structures. For instance, indoor map data 117A generated by the mapping system 110 can define aspects of an indoor environment 102, e.g., locations of walls, doorways, pathways, or other points of interest of a structure. The outdoor map data can also define aspects of an outdoor space, e.g., roads and other types of travel paths within a geographic area.

The map data can also include topography data and other data that may influence a commute of a user from one location to another. The map data can also include image data which may include still image or video image data of roads and paths within a geographic area as well as images of rooms, resources, buildings and other landmarks. The map data can be based on global positioning coordinates, coordinates defined by private or public beacons, or any other suitable resource. The map data can include indoor map data 117A generated by the mapping system 110 and outdoor map data generated by the mapping system 110, or some other system. The map data can be utilized by one or more computing devices for various purposes, e.g., navigational purposes.

Referring now to FIG. 1C, the example shows mapping system 110 receiving interaction data 143 generated in response to users 101 interacting with resources within the indoor environment 102. The interaction data 143 can be utilized to identify the unidentified resources 146A-146E illustrated in FIG. 1B.

As briefly described above, the interaction data 143 can include data sent to a resource 144 and/or received from a resource 144 within the environment. For example, the user 101A may interact with a personal computing device resource 144A within an office. This interaction can include, but is not limited to establishing a wireless connection with the computing resource, issuing a command to the computing resource, receiving identifying data from the computing resource, and the like. As another example, the interaction data might be signing for a delivery of a letter or some other package, or some other type of interaction made by a user within the environment. Interaction data 143B is generated based on the user 101B interacting with a computing device resource 144B. Interaction data 143C is generated based on the user 101C interacting with a computing device resource 143C. Interaction data 143D is generated based on the user 101D interacting with display 144E. Interaction data 143E is generated based on the user 101E interacting with a secure entry doorway resource.

In this example, the mapping system 110 can identify the table 144D based on the pattern of movements with regard to the resource. For instance, the mapping system 110 analyzes the positioning data 142 and determines that the patterns of movement near the table 144D indicate that users move toward the table 144D, stay at locations near the table 144D for a period of time, and then leaves.

Referring now to FIG. 1D, the mapping system 110 updates indoor map data 117 to reflect a newly identified resource. In the example of FIG. 1D, a user 101 has issued a command to the resource 144F. For instance, the user 101 selected to print a document displayed on computing device 144B to a wireless printer 144F. After issuing the print command, the user 101 moves from the office to a common area in the hallway and waits for a period of time before returning to the office. In this example, the mapping system 110 can identify the location of the printer resource 144B using the positioning data 142F associated with the user (e.g., near a location where the user stops) and/or positioning data 142 obtained from some other positioning source, such as the access points 106. As discussed briefly above, the system can also use the amount of time the user waits at the location to identify the printer. In some configurations, the combination of the wait time along with a confirmation message from the printer that the document has printed can be utilized.

Turning now to FIG. 1E, metadata associated with the indoor map data 117A is illustrated. In the current example, the mapping system 110 generates metadata 117B-1-117B-10 to describe information about resources identified by the map data 117A. Metadata 117B-1 includes information that identifies the room number, the type of room (e.g., common area), the number and type of resources within the room, and the size of the room. The metadata may include more or less information. Metadata 117B-2 includes information that identifies the room as a hallway that has a size of 5 feet wide by 100 feet long. Metadata 117B-3 includes information that identifies that the room is an office, user 101B occupies the office, the office has a size of 12×12 and there is one computing device within the office. Metadata 117B-4 includes information that identifies that the room is an office, user 101A occupies the office, the office has a size of 12×10 and there is one computing device within the office. Metadata 117B-5 includes information that identifies that the room is an office, user 101C occupies the office, the office has a size of 12×10 and there is one computing device within the office.

In some configurations, the mapping system 110 identifies the occupant of an office based on the movement patterns identified in the positioning data 142. For example, the positioning data 142 may indicate that user 101B enters and exits room number 1002 the most often and spends the most time within the office. Metadata 117B-6 includes information that identifies the room as a hallway that has a size of 4 feet wide by 100 feet long. Metadata 117B-7 includes information that identifies the resource as a doorway that is 3 feet wide. Metadata 117B-8 includes information that identifies the resource as a conference room, the room number, the size of the conference room is 30×20, there is a 55 inch display and a conference room table that seats six within the conference room. Metadata 117B-9 includes information that identifies the resource as a television that is 4 feet wide. Metadata 117B-10 includes information that identifies the resource as an exterior three-foot doorway that has controlled access.

Referring now to FIG. 2, aspects of a system 200 for generating indoor map data is provided. It should be appreciated that the subject matter described herein can be implemented as a computer-controlled apparatus, a computer process, a computing system, or as an article of manufacture such as a computer-readable storage medium. These and various other features will be apparent from a reading of the following Detailed Description and a review of the associated drawings. Furthermore, the claimed subject matter is not limited to implementations that solve any or all disadvantages noted in any part of this disclosure.

As will be described in more detail herein, it can be appreciated that implementations of the techniques and technologies described herein may include the use of solid state circuits, digital logic circuits, computer component, and/or software executing on one or more devices. Signals described herein may include analog and/or digital signals for communicating a changed state, movement and/or any data associated with motion detection. Gestures, e.g., which can be in the form of any type of movement, captured by users of the computing devices can use any type of sensor or input device.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

By the use of the technologies described herein, a system can generate indoor map data for an indoor environment. Such technologies can improve the mapping of an indoor environment by identifying and defining the resources within the building. Configurations disclosed herein can be beneficial in assisting users and business entities by providing an up to date map of the inside of a building. Among many benefits provided by the technologies described herein, a user's knowledge of resources within an indoor environment may be improved, which may reduce the time to find a resource or a room, and reduce the time to add a new resource to an existing map. Other technical effects other than those mentioned herein can also be realized from implementations of the technologies disclosed herein.

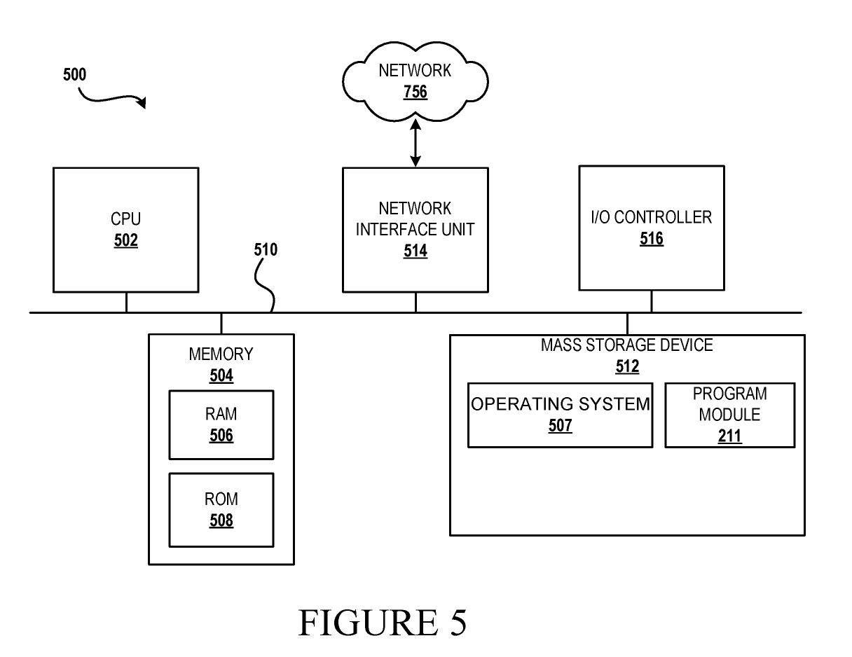

In the following description, references are made to the accompanying drawings that form a part hereof, and in which are shown by way of illustration specific configurations or examples. Referring to the system drawings, in which like numerals represent like elements throughout the several figures, aspects of a computing system, computer-readable storage medium, and computer-implemented methodologies for providing automated generation of indoor map data. As will be described in more detail below with respect to FIGS. 5-7, there are a number of applications and services that can embody the functionality and techniques described herein.

FIG. 2 is a block diagram showing aspects of one example system 200 disclosed herein for generating indoor map data. In one illustrative example, the example system 200 can include a mapping system 110, an authentication system 115, one or more client computing devices 202A-202B (“devices 202”), one or more database systems 125A-125B (generically referred to as “database systems 125”), and one or more networks 250. As will be described below, the devices 202 can be utilized for interaction with one or more users 101A-101B (“users 101”). As described above, user computing devices are associated with providing positioning data 142 and interaction data 143 to the mapping system 110. This example is provided for illustrative purposes and is not to be construed as limiting. It can be appreciated that the system 200 can include any number of devices, database systems, users, mapping systems, and/or any number of authentication systems.

The system 200 enables the client computing devices 202 to interact with a uniform interface for accessing different types of data that is stored in different database systems 125 and providing data to one or more systems associated with the mapping system 110. By providing a uniform interface, enabling users and clients to store and retrieve data from multiple noncontiguous databases with a single query, even if the database systems 125 are heterogeneous. In some configurations, a federated database system can decompose a query generated by a client computing device 202 into subqueries for submission to the relevant constituent database management systems, after which the system can composite the result sets of the subqueries. Because various database management systems can employ different query languages, the database systems 125 or the mapping system 110 can apply wrappers to the subqueries to translate them into the appropriate query languages.

For illustrative purposes, in the example shown in FIG. 2, the first database system 125A is a secured system storing indoor map data and metadata, the second database system 125B is a publicly accessible system, such as GOOGLE MAPS, storing outdoor map data, and the third database system 125C is another publicly accessible system, such as a generic search engine, social network, or ecommerce site, storing metadata. In some examples, metadata can include positioning data, which can indicate a position of a resource or user. When a client computing device 202 sends a request for interaction data stored at the database systems 125, the authentication system 115 can determine if the client computing device 202 is to receive the requested data. The authentication system 115 can also be used to authenticate a client computing device 202 before the client computing device 202 is allowed to provide positioning data and/or interaction data to the mapping system 110.

In some configurations, the mapping system 110, authentication system 115, and individual databases can be independently managed and/or administered by different business entities or different departments of an entity. For instance, administrative control of the mapping system 110 may be separated from the administrative control of the authentication system 115 by a management separation, staffing separation, or another arraignment where individuals or entities managing or controlling each data store do not overlap. In addition, administrative control of the individual database systems can each be separated from one another. Separation of the administrative control of each data store and the other components of the system 200 helps mitigate security concerns.

For illustrative purposes, the client computing device 202 may be associated with an organization, individual, company, machine, system, service, device, or any other entity that utilizes at least one identity having credentials stored at the authentication system 115. An identity, for example, may be associated with a user account, smart card, certificate or any other form of authentication. The individual, device, business or entity associated with the client computing device 202 may subscribe to, or at least utilize, services offered by the authentication system 115 without having the need for the authentication system 115 to store private metadata, such as indoor maps and other metadata. The mapping system 110 can store the private metadata and/or retrieve the private metadata from the various database systems 125. These examples are provided for illustrative purposes and are not to be construed as limiting. It can be appreciated that the systems and devices can be combined in different ways to create a desired separation of private data depending on the type of data that is stored.

The mapping system 110, authentication system 115, devices 202, and the database systems 125, and/or any other computer configured with the features disclosed herein can be interconnected through one or more local and/or wide area networks, such as the network 250. In addition, the computing devices can communicate using any technology, such as BLUETOOTH, WIFI, WIFI DIRECT, NFC or any other suitable technology, which may include light-based, wired, or wireless technologies. It should be appreciated that many more types of connections may be utilized than described herein.

Individual devices 202 can operate as a stand-alone device, or such devices can operate in conjunction with other computers, such as the one or more servers 120. Individual computing devices can be in the form of a personal computer, mobile phone, tablet, wearable computer, including a head-mounted display (HMD) or a watch, or any other computing device having components for interacting with one or more users 101. In one illustrative example, individual devices 202 and the provider device 104 can include a local memory (FIG. 5), also referred to herein as a “computer-readable storage medium,” configured to store data and code modules, such as a program module 211 and interaction data.

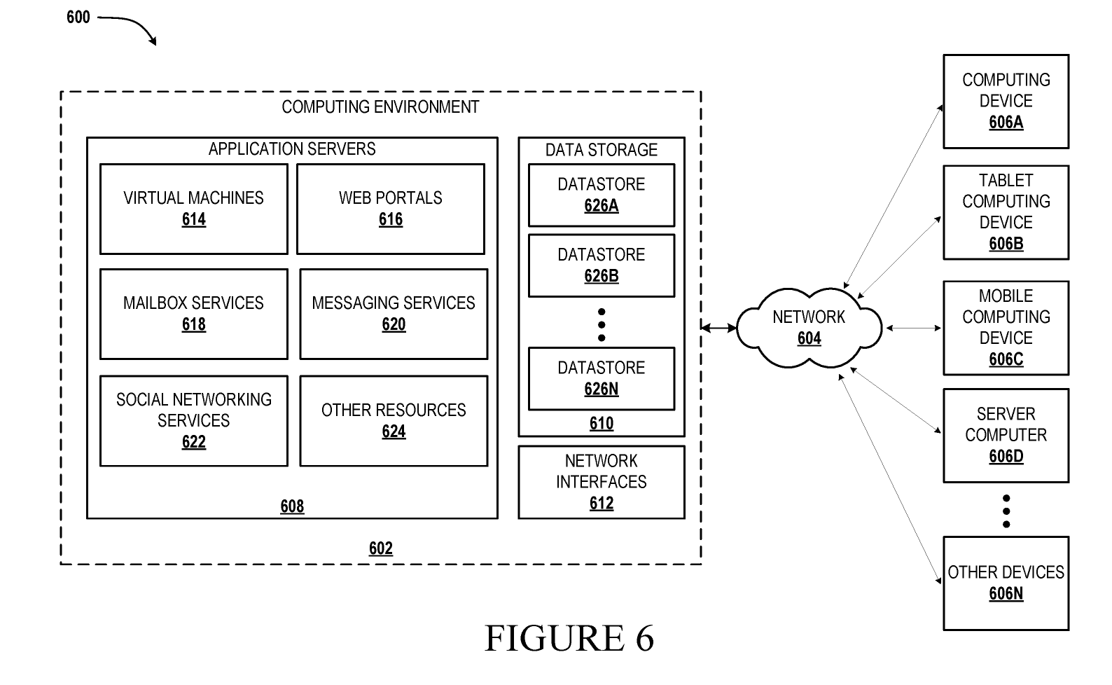

The mapping system 110, authentication system 115, and the database systems 125 can be in the form of a personal computer, a server farm, a large-scale system or any other computing system having components for processing, coordinating, collecting, storing, and/or communicating data between one or more computing devices. In one illustrative example, the servers 120 can include a local memory (FIG. 5), also referred to herein as a “computer-readable storage medium,” configured to store data and code modules, such as the mapping manager 116 and the authentication module 121. The mapping system 110, authentication system 115, and the database systems 125 can also include components and services, such as the application services and shown in FIG. 6, for providing, receiving, and processing positioning data, interaction data, as well as other data, and executing one or more aspects of the techniques described herein.

The authentication system 115 can operate one or more authentication services, such as MICROSOFT'S ACTIVE DIRECTORY or any other service operating an authentication protocol, such as OpenID, can be utilized to manage credentials and generate permission data for use by the mapping system. Credentials can be received at the authentication system 115 from one or more devices 202, and the authentication system 115 can generate permission data for enabling the mapping system 110 to control access to one or more resources 144. In addition, the mapping system 110, authentication system 115, and the database systems 125 can provide, or have access to, one or more services such as a service offering data management software, calendaring software, or other services.

In some configurations, the mapping system 110 comprises an application programming interface 119 (“API 119”) that exposes an interface through which an operating system and application programs executing on the computing device can enable the functionality disclosed herein. Through the use of this data interface and other interfaces, the operating system and application programs can communicate and process data.

In some configurations, specific portions of data can be secured by associating permission levels with one or more categories of data. In some examples, the system 200 shown in FIG. 2 comprises a first category of data having a first level of access, e.g., secured data 117, and a second category of data having a second level of access, e.g., unsecured data 118.

To illustrate aspects of this example, secured data 117 includes indoor map data 117A and secured metadata 117B. The unsecured data 118 includes outdoor map data 118A and unsecured metadata 118B. The metadata can include positioning data 142, which can indicate a position of a resource or user and interaction data 143, which can indicate interactions with a resource 144. In this example, the indoor map data 117A and secured metadata 117B are generated by the mapping system 110 and provided to the first database system 125A, e.g., a privately managed system. The outdoor map data 118A is provided by a second database system 125B, e.g., a publicly available system, and the unsecured metadata 118B is provided by a third database system 125C, e.g., a search engine, social network, etc. This example is provided for illustrative purposes and is not to be construed as limiting. It can be appreciated that any number of levels can be associated with any portion of data to enable granular levels of access for an identity, e.g., a user associated with an account, or a group of identities. It can also be appreciated that different types of interaction data can come from more or fewer computing devices.

The authentication system 115 can enable controlled access to one or more portions of data by associating identities with entries defining roles and/or privileges. The roles and/or privileges allow or deny the execution of operations to access and/or manage data for the one or more associated identities. Among many other implementations, techniques described herein utilize the access control list 122 and a mapping manager 116 to manage granular levels of access control to different types of data. For instance, the system 200 can allow one identity, or a first group of identities, to provide positioning data and interaction data, while prohibiting a second entity, or a second group of identities from providing the positioning data and the interaction data.

In some examples, the techniques disclosed herein can provide different levels of access to different individuals or groups of individuals. For instance, a first level of access can be granted for full-time employees of a company, and a second level of access can be granted for vendors or contractors. In the examples described below, access to secured data and other resources are granted to an individual identity. It can be appreciated that the techniques disclosed herein can also grant access to secured data and other resources to groups of identities.

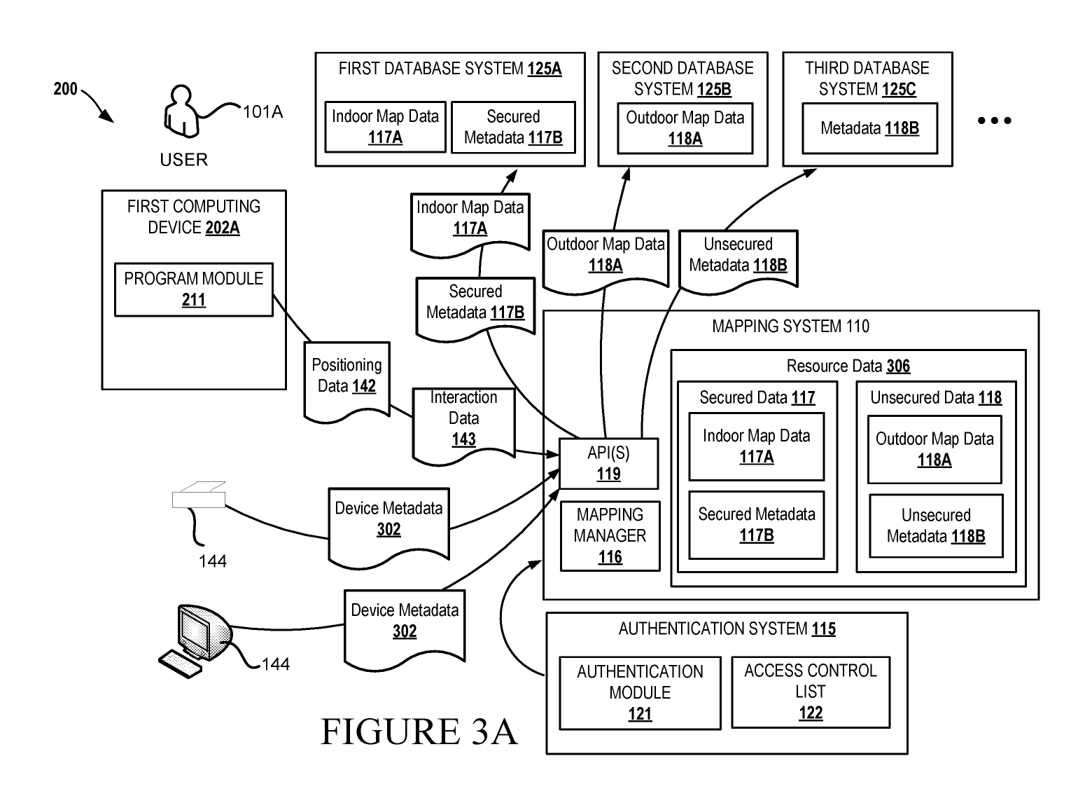

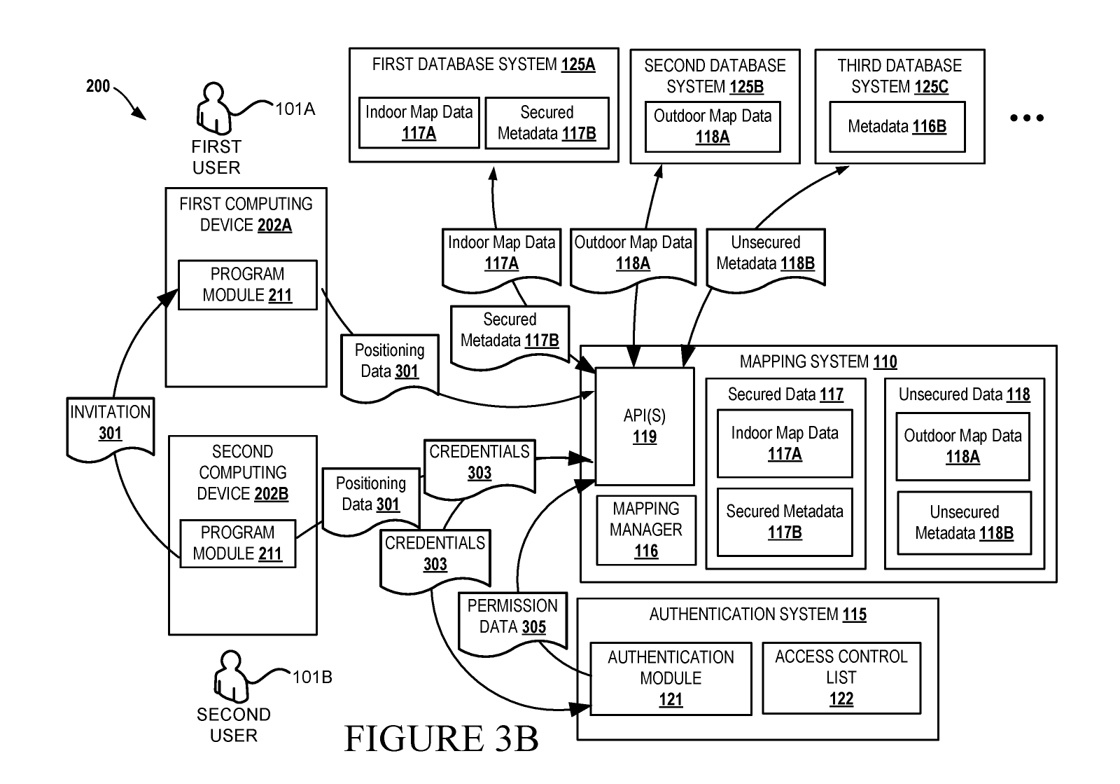

Referring now to FIGS. 3A-3B, an example data flow scenario involving the system 200 for automated generation of indoor map data is shown and described below. The example shown in FIGS. 3A-3B illustrates aspects of various types of data that is exchanged between computing devices of the system 200 in the scenario illustrated above with respect to FIGS. 1-E.

FIG. 3A illustrates that data, which may include secured data 117 and unsecured data 118, can be received from a number of database systems 125. Specifically, the indoor map data 117A and secured metadata 117B is generated by the mapping system 110 and provided to the first database system 125A. The outdoor map data 118A is provided by the second database system 125B, and the unsecured metadata 118B is provided by the third database system 125C. In this example, the first database system 125A can be a privately managed server, and the second database system 125B and the third database system 125C can be publicly accessible services, e.g., search engines, social networks, etc.

In this example, the user 101A utilizes first computing device 202A to provide positioning data 142 and interaction data 143 to the mapping system 110 using one or more of the API(s) 119. As described above, users can provide positioning data and interaction data to the mapping system 110 that indicates patterns of movement of the user and interactions the user has with one or more resources within the environment. After generating the indoor map data using one or more mapping techniques, the mapping system 110 may store the indoor map data 117A and metadata 117B within resource data 306. The mapping system 110 can also provide the indoor map data 117A and the secured metadata 117B to the first database system 125A. The mapping system 110 can also provide map data, such as outdoor map data, to the second database system 125B and unsecured metadata 118B to the third database system 125C.

Also, as shown in FIG. 3A, the resources 144 provide device metadata 302 to the mapping system via the API(s) 119. According to some configurations, the resources can provide the device metadata during an initialization process, or at some other time. In other examples, the mapping system 110 can perform a network discovery technique to identify devices connected to a network associated with the indoor environment 102. The device metadata 302 can define information such as, but not limited to, a device identifier, a type of device, a version of the device, and the like.

For example, techniques disclosed herein can enable a computing system to receive positioning data and interaction data from user computing devices. The system can generate the indoor map data 117A using the positioning data 142 and the interaction data 143 using one or more mapping techniques. For example, the movement patterns 103 can be analyzed to determine boundaries of rooms and other physical objects, and the interaction data 143 can be used by the system 110 to identify the computing resources 144 within the indoor environment 102.

As described above, the indoor map data 117A can identify resources of the indoor environment. The resources can include computing device resources and non-computing device resources within the indoor environment. For example, the map data can identify interior pathways, doorways, rooms, or other areas within the indoor environment, as well as computing resources and non-computing resources.

In some configurations, the first computing device 202A can continue to provide positioning data 142 and interaction data 143 after the indoor map data 117A is generated. This additional data can be used by the system to dynamically modify the generated indoor map data 117A based on positioning data and interaction data received after generating the map data. For example, the map data may not initially indicate the presence of a resource within the indoor environment.

Turning now to FIG. 3B, information associated with an invitation sent by a second user 101B to a first user 101A is used by the mapping system 110 to identify a resource. In the example illustrated in FIG. 3B, user 101A receives an invitation 301 from the second user 101B to attend a meeting at a conference room. In some configurations, the invitation 301 can be in the form of a calendar event identifying a location, e.g., the conference room. In such an example, the invitation 301 can be communicated from the second computing device 202B to the first computing device 202A, either directly or through a service, such as a calendaring service. In some configurations, the invitation 301 can be communicated to the mapping system 110. This example is provided for illustrative purposes and is not be construed as limiting. It can be appreciated that the invitation 301 can be and other forms, such as an email, text message, and instant message or any other form of communication suitable for identifying a location and identifying an identity associated with permissions for granting access to resources.

For example, the mapping system 110 may identify a conference room using positioning data 142 that indicates patterns of movement 103 for a group of users moving to the room at a particular time and then leaving the room after some period of time. In some configurations, the system 110 can utilize data other than, or in addition to, the positioning data 142 in identifying the room as a conference room. For instance, the invitation 301 can correlate that the user is attending a meeting at a particular time. These examples are provided for illustrative purposes and are not be construed as limiting. It can be appreciated that any suitable user activity or pattern of movement can be utilized to modify permissions associated with one or more resources.

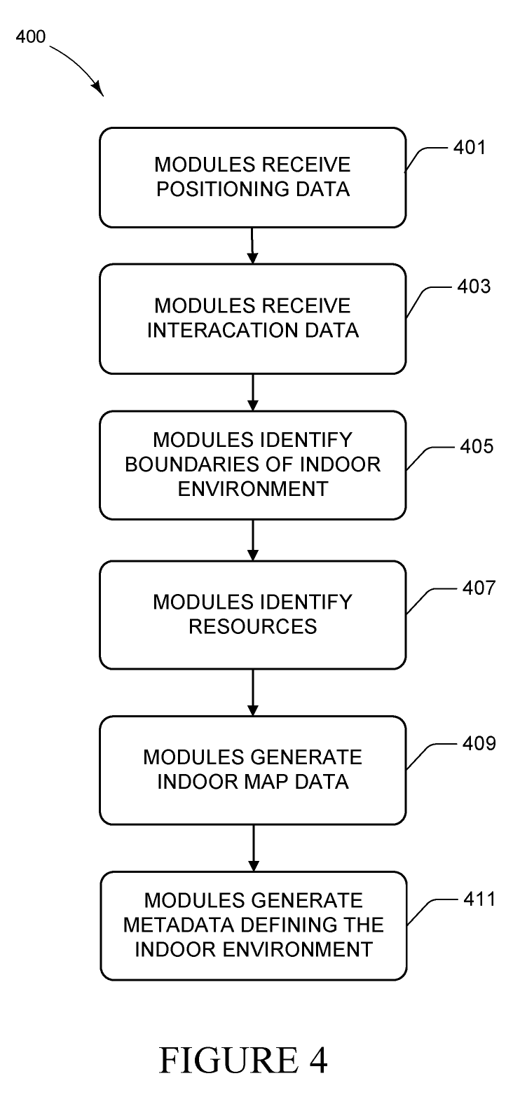

Turning now to FIG. 4, aspects of a routine 400 for automated generation of indoor map data 117A are shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 400 are described herein as being implemented, at least in part, by a mapping system 110, program module 211, and/or components of an operating system. In some configurations, the mapping system 110 including the mapping manager 116 or another module running the features disclosed herein can be a dynamically linked library (DLL), a statically linked library, functionality produced by an application programing interface (API), a compiled program, an interpreted program, a script or any other executable set of instructions. Data, such as positioning data 142, interaction data 143, and other data can be stored in a data structure in one or more memory components. Data can be retrieved from the data structure by addressing links or references to the data structure.

Although the following illustration refers to the components of the figures, it can be appreciated that the operations of the routine 400 may be also implemented in many other ways. For example, the routine 400 may be implemented, at least in part, by a processor of another remote computer or a local circuit. In addition, one or more of the operations of the routine 400 may alternatively or additionally be implemented, at least in part, by a chipset working alone or in conjunction with other software modules. In the example described below, one or more modules of a computing system, such as the mapping system 110 can receive and/or process the data disclosed herein. Any service, circuit or application suitable for providing the techniques disclosed herein can be used in operations described herein.

With reference to FIG. 4, the routine 400 begins at operation 401 where one or more modules of a computing system receive positioning data. As discussed above, the positioning data 142 can include data associated with the movement of a user within an indoor environment, such as movement of users inside a building. In some examples, mobile computing devices associated with users provide to the mapping system 110, positioning data 142 that includes velocity data and direction data for users moving within the indoor environment. Positioning data 142 may be received from computing devices 202 associated with the one or more identities or the positioning data 142 can be received from another system, which may have cameras and other devices that can track movement of individuals.

Next, at operation 403, one or more modules of a computing system can receive interaction data 143. As summarized above, the mapping system 110 can receive the interaction data 143 from computing devices associated with users that are within the indoor environment. As discussed above, the interaction data 143 can include information such as identifying information of resource, a command sent to the resource, data received from the resource, actions performed near the resource, and the like.

Next, at operation 405, one or more modules of a computing system can identify boundaries of an indoor environment. As summarized herein, boundaries of the indoor environment can be a boundaries associated with a hallway, an office, a conference room, a common area, a table, a desk, a chair, or some other type of room or object encountered within the indoor environment. According to some examples, the boundaries are identified from un-navigated areas of the indoor environment. Areas in which the positioning data shows that a user has navigated indicate open areas of the indoor environment.

Next, at operation 407, one or more modules of a computing device can identify resources 144. As summarized herein, the resources can include computing resources as well as non-computing resources. In some configurations, the mapping system 110 receives interaction data from one or more computing devices associated with users of the indoor environment that indicates an interaction with one or more resources within the indoor environment. According to some examples, the mapping system 110 can identify physical resources, such as the boundaries of the indoor environment, doorways, stairs, as well as other physical objects utilizing the positioning data 142, interaction data 143, and possibly other types of data. For instance, as discussed above, positioning data 142 in combination with data associated with an invitation 301 can be used to identify a conference room within an indoor environment. The positioning data 142 and interaction data 143 can also be used to identify tables, desks, chairs, and other physical objects within the indoor environment.

Next, at operation 409, one or more modules of a computing device can generate the indoor map data. In some configurations, the mapping system 110 generates the indoor map data 117A using the positioning data 142 and the interaction data 143. As discussed above, the mapping system 110 can identify physical boundaries of objects using the patterns of movement received from the user computing devices. The mapping system 110 can also identify a resource based on an interaction with the resource. For example, a user computing device can issue a command to a resource, the user computing device can receive data from the resource that identifies the device, and the like.

Next, at operation 411, one or more modules of a computing device can generate metadata defining the indoor environment. As summarized herein, the metadata can define a type of resource within the indoor environment, the size of the resource, others resources associated with the resource (e.g., a computing device within an office), other information about a resource and the like.

FIG. 5 shows additional details of an example computer architecture 500 for a computer, such as the computing device 202 (FIG. 2), capable of executing the program components described herein. Thus, the computer architecture 500 illustrated in FIG. 5 illustrates an architecture for a server computer, mobile phone, a PDA, a smart phone, a desktop computer, a netbook computer, a tablet computer, and/or a laptop computer. The computer architecture 500 may be utilized to execute any aspects of the software components presented herein.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing an operating system 507, other data, and one or more application programs.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes the claims, the phrase “computer storage medium,” “computer-readable storage medium” and variations thereof, does not include waves, signals, and/or other transitory and/or intangible communication media, per se.

According to various configurations, the computer architecture 500 may operate in a networked environment using logical connections to remote computers through the network 756 and/or another network (not shown). The computer architecture 500 may connect to the network 756 through a network interface unit 514 connected to the bus 510. It should be appreciated that the network interface unit 514 also may be utilized to connect to other types of networks and remote computer systems. The computer architecture 500 also may include an input/output controller 516 for receiving and processing input from a number of other devices, including a keyboard, mouse, or electronic stylus (not shown in FIG. 5). Similarly, the input/output controller 516 may provide output to a display screen, a printer, or other type of output device (also not shown in FIG. 5).

It should be appreciated that the software components described herein may, when loaded into the CPU 502 and executed, transform the CPU 502 and the overall computer architecture 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 may include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

FIG. 6 depicts an illustrative distributed computing environment 600 capable of executing the software components described herein for automated generation of indoor map data. Thus, the distributed computing environment 600 illustrated in FIG. 6 can be utilized to execute any aspects of the software components presented herein. For example, the distributed computing environment 600 can be utilized to execute aspects of the software components described herein.

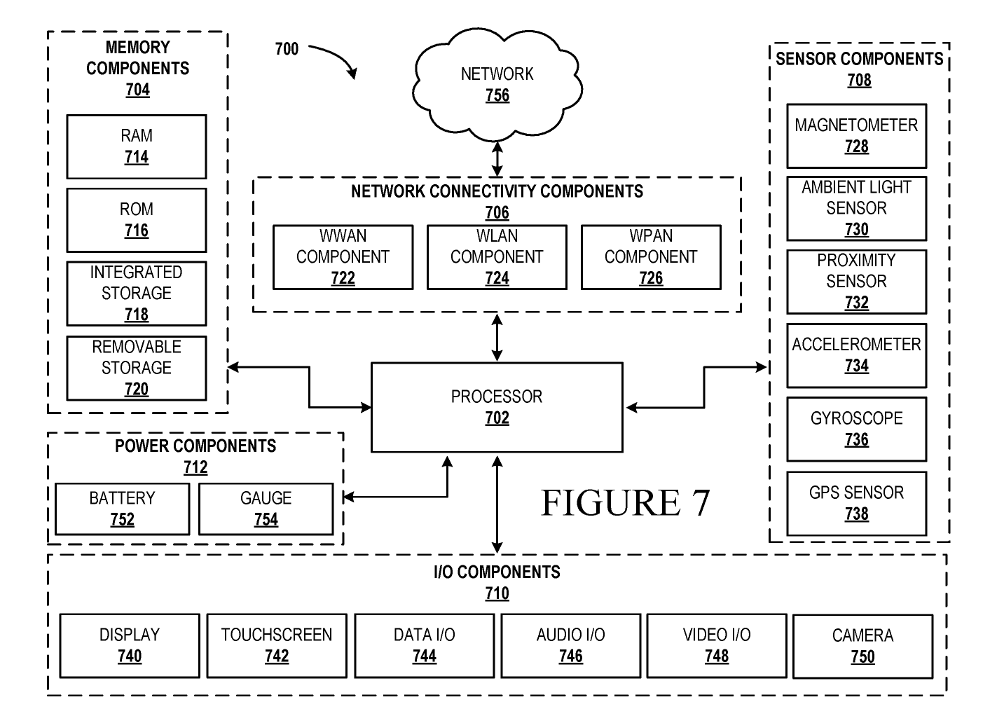

According to various implementations, the distributed computing environment 600 includes a computing environment 602 operating on, in communication with, or as part of the network 604. The network 604 may be or may include the network 756, described above with reference to FIG. 5. The network 604 also can include various access networks. One or more client devices 606A-606N (hereinafter referred to collectively and/or generically as “clients 606”) can communicate with the computing environment 602 via the network 604 and/or other connections (not illustrated in FIG. 6). In one illustrated configuration, the clients 606 include a computing device 606A such as a laptop computer, a desktop computer, or other computing device; a slate or tablet computing device (“tablet computing device”) 606B; a mobile computing device 606C such as a mobile telephone, a smart phone, or other mobile computing device; a server computer 606D; and/or other devices 606N. It should be understood that any number of clients 606 can communicate with the computing environment 602. Two example computing architectures for the clients 606 are illustrated and described herein with reference to FIGS. 5 and 7. It should be understood that the illustrated clients 606 and computing architectures illustrated and described herein are illustrative, and should not be construed as being limited in any way.

In the illustrated configuration, the computing environment 602 includes application servers 608, data storage 610, and one or more network interfaces 612. According to various implementations, the functionality of the application servers 608 can be provided by one or more server computers that are executing as part of, or in communication with, the network 604. The application servers 608 can host various services, virtual machines, portals, and/or other resources. In the illustrated configuration, the application servers 608 host one or more virtual machines 614 for hosting applications or other functionality. According to various implementations, the virtual machines 614 host one or more applications and/or software modules for providing automated generation of indoor map data. It should be understood that this configuration is illustrative, and should not be construed as being limiting in any way. The application servers 608 also host or provide access to one or more portals, link pages, Web sites, and/or other information (“Web portals”) 616.

According to various implementations, the application servers 608 also include one or more mailbox services 618 and one or more messaging services 620. The mailbox services 618 can include electronic mail (“email”) services. The mailbox services 618 also can include various personal information management (“PIM”) and presence services including, but not limited to, calendar services, contact management services, collaboration services, and/or other services. The messaging services 620 can include, but are not limited to, instant messaging services, chat services, forum services, and/or other communication services.

The application servers 608 also may include one or more social networking services 622. The social networking services 622 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 622 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 622 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 622 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 622 are not mentioned herein for the sake of brevity. As such, the above configurations are illustrative, and should not be construed as being limited in any way. According to various implementations, the social networking services 622 may host one or more applications and/or software modules for providing the functionality described herein, such as providing automated generation of indoor map data. For instance, any one of the application servers 608 may communicate or facilitate the functionality and features described herein. For instance, a social networking application, mail client, messaging client or a browser running on a phone or any other client 606 may communicate with a networking service 622 and facilitate the functionality, even in part, described above with respect to FIG. 4.

As shown in FIG. 6, the application servers 608 also can host other services, applications, portals, and/or other resources (“other resources”) 624. The other resources 624 can include, but are not limited to, document sharing, rendering or any other functionality. It thus can be appreciated that the computing environment 602 can provide integration of the concepts and technologies disclosed herein provided herein with various mailbox, messaging, social networking, and/or other services or resources.

As mentioned above, the computing environment 602 can include the data storage 610. According to various implementations, the functionality of the data storage 610 is provided by one or more databases operating on, or in communication with, the network 604. The functionality of the data storage 610 also can be provided by one or more server computers configured to host data for the computing environment 602. The data storage 610 can include, host, or provide one or more real or virtual datastores 626A-626N (hereinafter referred to collectively and/or generically as “datastores 626”). The datastores 626 are configured to host data used or created by the application servers 608 and/or other data. Although not illustrated in FIG. 6, the datastores 626 also can host or store web page documents, word documents, presentation documents, data structures, algorithms for execution by a recommendation engine, and/or other data utilized by any application program or another module. Aspects of the datastores 626 may be associated with a service for storing files.

The computing environment 602 can communicate with, or be accessed by, the network interfaces 612. The network interfaces 612 can include various types of network hardware and software for supporting communications between two or more computing devices including, but not limited to, the clients 606 and the application servers 608. It should be appreciated that the network interfaces 612 also may be utilized to connect to other types of networks and/or computer systems.

It should be understood that the distributed computing environment 600 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 600 provides the software functionality described herein as a service to the clients 606. It should be understood that the clients 606 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 600 to utilize the functionality described herein for providing automated generation of indoor map data, among other aspects. In one specific example, as summarized above, techniques described herein may be implemented, at least in part, by the web browser application 510 of FIG. 5, which works in conjunction with the application servers 608 of FIG. 6.

Turning now to FIG. 7, an illustrative computing device architecture 700 for a computing device that is capable of executing various software components described herein for providing automated generation of indoor map data. The computing device architecture 700 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like. The computing device architecture 700 is applicable to any of the clients 606 shown in FIG. 6. Moreover, aspects of the computing device architecture 700 may be applicable to traditional desktop computers, portable computers (e.g., phones, laptops, notebooks, ultra-portables, and netbooks), server computers, and other computer systems, such as described herein with reference to FIG. 5. For example, the single touch and multi-touch aspects disclosed herein below may be applied to desktop computers that utilize a touchscreen or some other touch-enabled device, such as a touch-enabled track pad or touch-enabled mouse.

The computing device architecture 700 illustrated in FIG. 7 includes a processor 702, memory components 704, network connectivity components 706, sensor components 708, input/output components 710, and power components 712. In the illustrated configuration, the processor 702 is in communication with the memory components 704, the network connectivity components 706, the sensor components 708, the input/output (“I/O”) components 710, and the power components 712. Although no connections are shown between the individuals components illustrated in FIG. 7, the components can interact to carry out device functions. In some configurations, the components are arranged so as to communicate via one or more busses (not shown).

The processor 702 includes a central processing unit (“CPU”) configured to process data, execute computer-executable instructions of one or more application programs, and communicate with other components of the computing device architecture 700 in order to perform various functionality described herein. The processor 702 may be utilized to execute aspects of the software components presented herein and, particularly, those that utilize, at least in part, a touch-enabled input.

In some configurations, the processor 702 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 720P, 1080P, and higher resolution), video games, three-dimensional (“3D”) modeling applications, and the like. In some configurations, the processor 702 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some configurations, the processor 702 is, or is included in, a system-on-chip (“SoC”) along with one or more of the other components described herein below. For example, the SoC may include the processor 702, a GPU, one or more of the network connectivity components 706, and one or more of the sensor components 708. In some configurations, the processor 702 is fabricated, in part, utilizing a package-on-package (“PoP”) integrated circuit packaging technique. The processor 702 may be a single core or multi-core processor.

The processor 702 may be created in accordance with an ARM architecture, available for license from ARM HOLDINGS of Cambridge, United Kingdom. Alternatively, the processor 702 may be created in accordance with an x86 architecture, such as is available from INTEL CORPORATION of Mountain View, Calif. and others. In some configurations, the processor 702 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 704 include a random access memory (“RAM”) 714, a read-only memory (“ROM”) 716, an integrated storage memory (“integrated storage”) 718, and a removable storage memory (“removable storage”) 720. In some configurations, the RAM 714 or a portion thereof, the ROM 716 or a portion thereof, and/or some combination the RAM 714 and the ROM 716 is integrated in the processor 702. In some configurations, the ROM 716 is configured to store a firmware, an operating system or a portion thereof (e.g., operating system kernel), and/or a bootloader to load an operating system kernel from the integrated storage 718 and/or the removable storage 720.

The integrated storage 718 can include a solid-state memory, a hard disk, or a combination of solid-state memory and a hard disk. The integrated storage 718 may be soldered or otherwise connected to a logic board upon which the processor 702 and other components described herein also may be connected. As such, the integrated storage 718 is integrated in the computing device. The integrated storage 718 is configured to store an operating system or portions thereof, application programs, data, and other software components described herein.

The removable storage 720 can include a solid-state memory, a hard disk, or a combination of solid-state memory and a hard disk. In some configurations, the removable storage 720 is provided in lieu of the integrated storage 718. In other configurations, the removable storage 720 is provided as additional optional storage. In some configurations, the removable storage 720 is logically combined with the integrated storage 718 such that the total available storage is made available as a total combined storage capacity. In some configurations, the total combined capacity of the integrated storage 718 and the removable storage 720 is shown to a user instead of separate storage capacities for the integrated storage 718 and the removable storage 720.

The removable storage 720 is configured to be inserted into a removable storage memory slot (not shown) or other mechanism by which the removable storage 720 is inserted and secured to facilitate a connection over which the removable storage 720 can communicate with other components of the computing device, such as the processor 702. The removable storage 720 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 704 can store an operating system. According to various configurations, the operating system includes, but is not limited to WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 706 include a wireless wide area network component (“WWAN component”) 722, a wireless local area network component (“WLAN component”) 724, and a wireless personal area network component (“WPAN component”) 726. The network connectivity components 706 facilitate communications to and from the network 756 or another network, which may be a WWAN, a WLAN, or a WPAN. Although only the network 756 is illustrated, the network connectivity components 706 may facilitate simultaneous communication with multiple networks, including the network 604 of FIG. 6. For example, the network connectivity components 706 may facilitate simultaneous communications with multiple networks via one or more of a WWAN, a WLAN, or a WPAN.

The network 756 may be or may include a WWAN, such as a mobile telecommunications network utilizing one or more mobile telecommunications technologies to provide voice and/or data services to a computing device utilizing the computing device architecture 700 via the WWAN component 722. The mobile telecommunications technologies can include, but are not limited to, Global System for Mobile communications (“GSM”), Code Division Multiple Access (“CDMA”) ONE, CDMA7000, Universal Mobile Telecommunications System (“UMTS”), Long Term Evolution (“LTE”), and Worldwide Interoperability for Microwave Access (“WiMAX”). Moreover, the network 756 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 756 may be configured to provide voice and/or data communications with any combination of the above technologies. The network 756 may be configured to or adapted to provide voice and/or data communications in accordance with future generation technologies.

In some configurations, the WWAN component 722 is configured to provide dual-multi-mode connectivity to the network 756. For example, the WWAN component 722 may be configured to provide connectivity to the network 756, wherein the network 756 provides service via GSM and UNITS technologies, or via some other combination of technologies. Alternatively, multiple WWAN components 722 may be utilized to perform such functionality, and/or provide additional functionality to support other non-compatible technologies (i.e., incapable of being supported by a single WWAN component). The WWAN component 722 may facilitate similar connectivity to multiple networks (e.g., a UMTS network and an LTE network).

The network 756 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 724 is configured to connect to the network 756 via the WI-FI access points. Such connections may be secured via various encryption technologies including, but not limited, WI-FI Protected Access (“WPA”), WPA2, Wired Equivalent Privacy (“WEP”), and the like.

The network 756 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 726 is configured to facilitate communications with other devices, such as peripherals, computers, or other computing devices via the WPAN.

The sensor components 708 include a magnetometer 728, an ambient light sensor 730, a proximity sensor 732, an accelerometer 734, a gyroscope 736, and a Global Positioning System sensor (“GPS sensor”) 738. It is contemplated that other sensors, such as, but not limited to, temperature sensors or shock detection sensors, also may be incorporated in the computing device architecture 700.

The magnetometer 728 is configured to measure the strength and direction of a magnetic field. In some configurations the magnetometer 728 provides measurements to a compass application program stored within one of the memory components 704 in order to provide a user with accurate directions in a frame of reference including the cardinal directions, north, south, east, and west. Similar measurements may be provided to a navigation application program that includes a compass component. Other uses of measurements obtained by the magnetometer 728 are contemplated.

The ambient light sensor 730 is configured to measure ambient light. In some configurations, the ambient light sensor 730 provides measurements to an application program stored within one the memory components 704 in order to automatically adjust the brightness of a display (described below) to compensate for low-light and high-light environments. Other uses of measurements obtained by the ambient light sensor 730 are contemplated.

The proximity sensor 732 is configured to detect the presence of an object or thing in proximity to the computing device without direct contact. In some configurations, the proximity sensor 732 detects the presence of a user's body (e.g., the user's face) and provides this information to an application program stored within one of the memory components 704 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 732 are contemplated.

The accelerometer 734 is configured to measure proper acceleration. In some configurations, output from the accelerometer 734 is used by an application program as an input mechanism to control some functionality of the application program. For example, the application program may be a video game in which a character, a portion thereof, or an object is moved or otherwise manipulated in response to input received via the accelerometer 734. In some configurations, output from the accelerometer 734 is provided to an application program for use in switching between landscape and portrait modes, calculating coordinate acceleration, or detecting a fall. Other uses of the accelerometer 734 are contemplated.

The gyroscope 736 is configured to measure and maintain orientation. In some configurations, output from the gyroscope 736 is used by an application program as an input mechanism to control some functionality of the application program. For example, the gyroscope 736 can be used for accurate recognition of movement within a 3D environment of a video game application or some other application. In some configurations, an application program utilizes output from the gyroscope 736 and the accelerometer 734 to enhance control of some functionality of the application program. Other uses of the gyroscope 736 are contemplated.

The GPS sensor 738 is configured to receive signals from GPS satellites for use in calculating a location. The location calculated by the GPS sensor 738 may be used by any application program that requires or benefits from location information. For example, the location calculated by the GPS sensor 738 may be used with a navigation application program to provide directions from the location to a destination or directions from the destination to the location. Moreover, the GPS sensor 738 may be used to provide location information to an external location-based service, such as E911 service. The GPS sensor 738 may obtain location information generated via WI-FI, WIMAX, and/or cellular triangulation techniques utilizing one or more of the network connectivity components 706 to aid the GPS sensor 738 in obtaining a location fix. The GPS sensor 738 may also be used in Assisted GPS (“A-GPS”) systems. The GPS sensor 738 can also operate in conjunction with other components, such as the processor 702, to generate positioning data for the computing device 700.

The I/O components 710 include a display 740, a touchscreen 742, a data I/O interface component (“data I/O”) 744, an audio I/O interface component (“audio I/O”) 746, a video I/O interface component (“video I/O”) 748, and a camera 750. In some configurations, the display 740 and the touchscreen 742 are combined. In some configurations two or more of the data I/O component 744, the audio I/O component 746, and the video I/O component 748 are combined. The I/O components 710 may include discrete processors configured to support the various interface described below, or may include processing functionality built-in to the processor 702.

The display 740 is an output device configured to present information in a visual form. In particular, the display 740 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 740 is a liquid crystal display (“LCD”) utilizing any active or passive matrix technology and any backlighting technology (if used). In some configurations, the display 740 is an organic light emitting diode (“OLED”) display. Other display types are contemplated.

The touchscreen 742, also referred to herein as a “touch-enabled screen,” is an input device configured to detect the presence and location of a touch. The touchscreen 742 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some configurations, the touchscreen 742 is incorporated on top of the display 740 as a transparent layer to enable a user to use one or more touches to interact with objects or other information presented on the display 740. In other configurations, the touchscreen 742 is a touch pad incorporated on a surface of the computing device that does not include the display 740. For example, the computing device may have a touchscreen incorporated on top of the display 740 and a touch pad on a surface opposite the display 740.

In some configurations, the touchscreen 742 is a single-touch touchscreen. In other configurations, the touchscreen 742 is a multi-touch touchscreen. In some configurations, the touchscreen 742 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 742. As such, a developer may create gestures that are specific to a particular application program.

In some configurations, the touchscreen 742 supports a tap gesture in which a user taps the touchscreen 742 once on an item presented on the display 740. The tap gesture may be used for various reasons including, but not limited to, opening or launching whatever the user taps. In some configurations, the touchscreen 742 supports a double tap gesture in which a user taps the touchscreen 742 twice on an item presented on the display 740. The double tap gesture may be used for various reasons including, but not limited to, zooming in or zooming out in stages. In some configurations, the touchscreen 742 supports a tap and hold gesture in which a user taps the touchscreen 742 and maintains contact for at least a pre-defined time. The tap and hold gesture may be used for various reasons including, but not limited to, opening a context-specific menu.

In some configurations, the touchscreen 742 supports a pan gesture in which a user places a finger on the touchscreen 742 and maintains contact with the touchscreen 742 while moving the finger on the touchscreen 742. The pan gesture may be used for various reasons including, but not limited to, moving through screens, images, or menus at a controlled rate. Multiple finger pan gestures are also contemplated. In some configurations, the touchscreen 742 supports a flick gesture in which a user swipes a finger in the direction the user wants the screen to move. The flick gesture may be used for various reasons including, but not limited to, scrolling horizontally or vertically through menus or pages. In some configurations, the touchscreen 742 supports a pinch and stretch gesture in which a user makes a pinching motion with two fingers (e.g., thumb and forefinger) on the touchscreen 742 or moves the two fingers apart. The pinch and stretch gesture may be used for various reasons including, but not limited to, zooming gradually in or out of a web site, map, or picture.

Although the above gestures have been described with reference to the use one or more fingers for performing the gestures, other appendages such as toes or objects such as styluses may be used to interact with the touchscreen 742. As such, the above gestures should be understood as being illustrative and should not be construed as being limiting in any way.

The data I/O interface component 744 is configured to facilitate input of data to the computing device and output of data from the computing device. In some configurations, the data I/O interface component 744 includes a connector configured to provide wired connectivity between the computing device and a computer system, for example, for synchronization operation purposes. The connector may be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 746 is configured to provide audio input and/or output capabilities to the computing device. In some configurations, the audio I/O interface component 746 includes a microphone configured to collect audio signals. In some configurations, the audio I/O interface component 746 includes a headphone jack configured to provide connectivity for headphones or other external speakers. In some configurations, the audio I/O interface component 746 includes a speaker for the output of audio signals. In some configurations, the audio I/O interface component 746 includes an optical audio cable out.

The video I/O interface component 748 is configured to provide video input and/or output capabilities to the computing device. In some configurations, the video I/O interface component 748 includes a video connector configured to receive video as input from another device (e.g., a video media player such as a DVD or BLURAY player) or send video as output to another device (e.g., a monitor, a television, or some other external display). In some configurations, the video I/O interface component 748 includes a High-Definition Multimedia Interface (“HDMI”), mini-HDMI, micro-HDMI, DisplayPort, or proprietary connector to input/output video content. In some configurations, the video I/O interface component 748 or portions thereof is combined with the audio I/O interface component 746 or portions thereof.

The camera 750 can be configured to capture still images and/or video. The camera 750 may utilize a charge coupled device (“CCD”) or a complementary metal oxide semiconductor (“CMOS”) image sensor to capture images. In some configurations, the camera 750 includes a flash to aid in taking pictures in low-light environments. Settings for the camera 750 may be implemented as hardware or software buttons.

Although not illustrated, one or more hardware buttons may also be included in the computing device architecture 700. The hardware buttons may be used for controlling some operational aspect of the computing device. The hardware buttons may be dedicated buttons or multi-use buttons. The hardware buttons may be mechanical or sensor-based.

The illustrated power components 712 include one or more batteries 752, which can be connected to a battery gauge 754. The batteries 752 may be rechargeable or disposable. Rechargeable battery types include, but are not limited to, lithium polymer, lithium ion, nickel cadmium, and nickel metal hydride. Each of the batteries 752 may be made of one or more cells.

The battery gauge 754 can be configured to measure battery parameters such as current, voltage, and temperature. In some configurations, the battery gauge 754 is configured to measure the effect of a battery's discharge rate, temperature, age and other factors to predict remaining life within a certain percentage of error. In some configurations, the battery gauge 754 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 712 may also include a power connector, which may be combined with one or more of the aforementioned I/O components 710. The power components 712 may interface with an external power system or charging equipment via an I/O component.

The disclosure presented herein may be considered in view of the following clauses.

Clause A: A computer-implemented method, comprising: receiving, from at least one computing device, positioning data that indicates a pattern of movement, within a building, of the at least one computing device; receiving, from the at least one computing device, interaction data that indicates an interaction with a resource within the building; determining one or more characteristics of the resource, including a location of the resource based, at least in part, on one or more of the positioning data or the interaction data; generating map data based, at least in part, on the positioning data and the interaction data, wherein the map data defines interior boundaries of the building and defines the location of the resource within the building; generating metadata defining the location of the resource and one or more characteristics associated with the interior boundaries of the building; and communicating the map data and the metadata to at least one database system.

Clause B. The computer-implemented method of Clause A, wherein the interaction data comprises one or more of data obtained from the resource or data provided to the resource.

Clause C. The computer-implemented method of Clauses A-B, wherein the positioning data includes a velocity and a direction of travel, and wherein generating the map data is based at least in part on the velocity and direction.

Clause D. The computer-implemented method of Clauses A-C, wherein generating the map data comprises identifying one or more of a floor of a building, a hallway, a doorway, an office, or a conference room based, at least in part, on one or more of the positioning data or the interaction data.

Clause E. The computer-implemented method of Clauses A-D, wherein determining the one or more characteristics of the resource comprises identifying a type of the resource based, at least in part, on a command sent to the resource or data received from the resource.

Clause F. The computer-implemented method of Clauses A-E, wherein generating the map data comprises identifying a conference room based, at least in part, on an invitation sent to a plurality of users to attend a meeting, and the positioning data indicating movement to a location associated with the conference room.

Clause G. The computer-implemented method of Clauses A-H, further comprising updating the map data based, at least in part, on one or more of identifying another resource or obtaining additional positioning data.

Clause H. A system, comprising: a processor; and a memory in communication with the processor, the memory having computer-readable instructions stored thereupon that, when executed by the processor, cause the processor to receive, from at least one computing device, positioning data that indicates a pattern of movement of the at least one computing device within an indoor environment; receive, from the at least one computing device, interaction data that indicates an interaction with computing resources within the indoor environment; generate map data identifying rooms and identifying at least one of the computing resources within the indoor environment based, at least in part, on one or more of the positioning data or the interaction data; and provide the map data to at least one database system.

Clause I. The system of Clause H, wherein the instructions cause the processor to determine a location of the at least one of the computing resources.

Clause J. The system of Clauses H-I, wherein the instructions cause the processor to generate metadata defining the location of the at least one of the computing resources and interior boundaries of at least a portion of the rooms.

Clause K. The system of Clauses H-J, wherein generating the map data is based at least in part on a pattern of movement identified from the positioning data.

Clause L. The system of Clauses H-K, wherein generating the map data comprises identifying a hallway, a doorway, an office, and a conference room based, a location of a desk within a room, at least in part, on the positioning data.

Clause M. The system of Clauses H-L, wherein the instructions cause the processor to identify a type for the at least one of the computing resources based, at least in part, on one or more of a command sent by the at least one computing device or data received by the at least one computing device.

Clause N. The system of Clauses H-M, wherein generating the map data comprises identifying a conference room based, at least in part, on an invitation to attend a meeting, and the positioning data indicating movement to a location associated with the conference room, wherein the invitation defines a meeting time and a name of a conference room, and wherein generating the map data comprises assigning the conference room the name.

Clause O. The system of Clauses H-N, wherein the instructions cause the processor to update the map data based, at least in part, in response to identifying a new resource.

Clause P. A computer-readable storage medium having computer-executable instructions stored thereupon which, when executed by a one or more processors of a computing device, cause the one or more processors of the computing device to: receive, from at least one computing device, one or more of positioning data that indicates a pattern of movement of the at least one computing device within a building or interaction data that indicates an interaction with one or more resources within the indoor environment; determine one or more characteristics of a resource, including a location of a printer within the building based, at least in part, on one or more of the positioning data or the interaction data; generate map data identifying rooms within the building and identifying the resource within the building based, at least in part, on one or more of the positioning data or the interaction data; generate metadata defining the location of the resource and defining one or more characteristics of the rooms; and

communicate the metadata to at least one database system.

Clause Q. The computer-readable storage medium of Clause P, wherein the interaction data comprises data obtained from the resource or data provided to the resource.

Clause R. The computer-readable storage medium of Clauses P-Q, wherein the positioning data includes a velocity and a direction of travel, and wherein generating the map data is based at least in part on the velocity and direction.

Clause S. The computer-readable storage medium of Clauses P-R, wherein generating the map data comprises identifying a hallway, a doorway, an office, and a conference room based, at least in part, on one or more of the positioning data or the interaction data.

Clause T. The computer-readable storage medium of Clauses P-S, wherein generating the map data comprises identifying a conference room based, at least in part, on an invitation to attend a meeting sent to a plurality of users, and the positioning data indicating movement to a location before a time associated with the invitation.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A computer-implemented method, comprising:
receiving, from at least one computing device, positioning data that indicates a pattern of movement, within a building, of the at least one computing device;
receiving, from the at least one computing device, interaction data that indicates an interaction with a resource within the building;
determining one or more characteristics of the resource, including a location of the resource based, at least in part, on one or more of the positioning data or the interaction data;
generating map data based, at least in part, on the positioning data and the interaction data, wherein the map data defines interior boundaries of the building and defines the location of the resource within the building;
generating metadata defining the location of the resource and one or more characteristics associated with the interior boundaries of the building; and
communicating the map data and the metadata to at least one database system.

2. The computer-implemented method of claim 1, wherein the interaction data comprises one or more of data obtained from the resource or data provided to the resource.

3. The computer-implemented method of claim 1, wherein the positioning data includes a velocity and a direction of travel, and wherein generating the map data is based at least in part on the velocity and direction.

4. The computer-implemented method of claim 1, wherein generating the map data comprises identifying one or more of a floor of a building, a hallway, a doorway, an office, or a conference room based, at least in part, on one or more of the positioning data or the interaction data.

5. The computer-implemented method of claim 1, wherein determining the one or more characteristics of the resource comprises identifying a type of the resource based, at least in part, on a command sent to the resource or data received from the resource.

6. The computer-implemented method of claim 1, wherein generating the map data comprises identifying a conference room based, at least in part, on an invitation sent to a plurality of users to attend a meeting, and the positioning data indicating movement to a location associated with the conference room.

7. The computer-implemented method of claim 1, further comprising updating the map data based, at least in part, on one or more of identifying another resource or obtaining additional positioning data.

8. A system, comprising:
a processor; and
a memory in communication with the processor, the memory having computer-readable instructions stored thereupon that, when executed by the processor, cause the processor to
receive, from at least one computing device, positioning data that indicates a pattern of movement of the at least one computing device within an indoor environment;
receive, from the at least one computing device, interaction data that indicates an interaction with computing resources within the indoor environment;
generate map data identifying rooms and identifying at least one of the computing resources within the indoor environment based, at least in part, on one or more of the positioning data or the interaction data; and
provide the map data to at least one database system.

9. The system of claim 8, wherein the instructions cause the processor to determine a location of the at least one of the computing resources.

10. The system of claim 8, wherein the instructions cause the processor to generate metadata defining the location of the at least one of the computing resources and interior boundaries of at least a portion of the rooms.

11. The system of claim 8, wherein generating the map data is based at least in part on a pattern of movement identified from the positioning data.

12. The system of claim 8, wherein generating the map data comprises identifying a hallway, a doorway, an office, and a conference room based, a location of a desk within a room, at least in part, on the positioning data.

13. The system of claim 8, wherein the instructions cause the processor to identify a type for the at least one of the computing resources based, at least in part, on one or more of a command sent by the at least one computing device or data received by the at least one computing device.

14. The system of claim 8, wherein generating the map data comprises identifying a conference room based, at least in part, on an invitation to attend a meeting, and the positioning data indicating movement to a location associated with the conference room, wherein the invitation defines a meeting time and a name of a conference room, and wherein generating the map data comprises assigning the conference room the name.

15. The system of claim 8, wherein the instructions cause the processor to update the map data based, at least in part, in response to identifying a new resource.

16. A computer-readable storage medium having computer-executable instructions stored thereupon which, when executed by a one or more processors of a computing device, cause the one or more processors of the computing device to:
receive, from at least one computing device, one or more of positioning data that indicates a pattern of movement of the at least one computing device within a building or interaction data that indicates an interaction with one or more resources within the indoor environment;
determine one or more characteristics of a resource, including a location of a printer within the building based, at least in part, on one or more of the positioning data or the interaction data;
generate map data identifying rooms within the building and identifying the resource within the building based, at least in part, on one or more of the positioning data or the interaction data;
generate metadata defining the location of the resource and defining one or more characteristics of the rooms; and
communicate the metadata to at least one database system.

17. The computer-readable storage medium of claim 16, wherein the interaction data comprises data obtained from the resource or data provided to the resource.

18. The computer-readable storage medium of claim 16, wherein the positioning data includes a velocity and a direction of travel, and wherein generating the map data is based at least in part on the velocity and direction.

19. The computer-readable storage medium of claim 16, wherein generating the map data comprises identifying a hallway, a doorway, an office, and a conference room based, at least in part, on one or more of the positioning data or the interaction data.

20. The computer-readable storage medium of claim 16, wherein generating the map data comprises identifying a conference room based, at least in part, on an invitation to attend a meeting sent to a plurality of users, and the positioning data indicating movement to a location before a time associated with the invitation.
